(19) United States
(12) Patent Application Publication
(10) Pub. No.: US 2017/0312182 A1
(43) Pub. Date: Nov. 2, 2017

(54) MEDICINE DISPENSING DEVICE FOR DISTRIBUTING MEDICINE PILLS AUTOMATICALLY

(71) Applicant: Pucun MA, Beijing (CN)

(72) Inventor: Pucun MA, Beijing (CN)

(21) Appl. No.: 15/345,514

(22) Filed: Nov. 8, 2016

(30) Foreign Application Priority Data
Apr. 29, 2016 (CN) 201610282260.1

(51) Int. Cl. A61J 7/00

(52) U.S. Cl. CPC A61J 7/0084

(57) ABSTRACT

The present invention discloses a medicine dispensing device for distributing medicine pills automatically, comprising a medicine supply system, a sorting system and a control system. The medicine supply system comprises a plurality of medicine supply units. The sorting system comprises a negative pressure medicine receiving mechanism, a camera subsystem, and two temporary storage cabins for medicine dispensing and discarding. The negative pressure medicine receiving mechanism has a negative pressure sucking head for sucking medicine pills. The negative pressure sucking head sucks a single medicine pill from a corresponding medicine supply unit. The camera subsystem captures images of medicine pills and sends the images to the control system. The camera subsystem recognizes the image of sucked medicine pill to identify the type, quantity and integrity of the medicine pill. This device fills the gap of no household automatic oral medicine dispensing device.

### BACKGROUND OF THE INVENTION

The present invention relates to the technical field of automation of household appliances, in particular to a medicine dispensing device for distributing medicine pills automatically.

Middle and old aged people suffering chronic diseases need to take medicines for a long time. Their prescriptions are usually complicated. At present, individual or family members who take medicines need help in manual medicine dispensing. Errors, even mistakes of mixing the prescriptions, occasionally occur during the medicine dispensing. In the long run, taking wrong medicines may be fatal. Now, more and more old people live alone. Living out life in retirement at home is also a main trend. The more the patients fail to be adapted to complicated medicine dispensing work, the more the patients will suffer the danger of taking wrong medicines. Labor service fails to cope with such trend.

Many patients with the above mentioned characteristics are found in medium-and-small-sized hospitals and retirement homes. Even if nurses are specially assigned to dispense the medicines to meet the medicine taking demands, the complicated and intensive labor may still result in the risk of dispensing wrong medicines. The medicine dispensing work has certain difficulties and responsibilities, causing burdens onto medical staff, and also increasing labor cost of user departments.

Along with the development of the aging society, a device for providing automatic medical dispensing services for individuals, houses or patient groups of a certain scale is an objective and urgent need, so people can be free from complicated medicine dispensing work to obtain higher living quality and better healthy guarantee.

A Chinese patent, publication No. CN 101786270A, discloses a multi-dimensional smart medicine dispensing robot system which adopts a central medicine dispensing principle. The multi-dimensional smart medicine dispensing robot system is generally applied to large-and-medium-sized hospitals, capable of automatically dividing medicines that a patient needs to take into single-dose packages according to advices of a doctor, and printing information such as the patient area, bed No., patient name, medicine name, medicine receiving time, quantity and bar code at the same time, to ensure that the medicines can be correctly handed to the patient after the dispensing.

A Chinese patent, Publication No. CN 101792052A, discloses a clutch-type automatic medicine guide device which adopts a basic principle of mold screening and counting, which means that through-holes identically shaped as the medicine pills are matched with medicine pills and the medicine pills pass the through-holes one by one with the aid of rotation doors. Medicine tanks manufactured under such conditions only cope with predetermined medicine varieties. During actual operation, least frequently used medicines or medicines newly added into the prescription need to be manually dispensed into standby medicine disks.

Medicine packing machines are products not oriented to individuals or families and usually have a volume of 3m3 or above, and all designs are subject to the standard of industrial automated devices. Besides, the medicine packing machines are very expensive (million-level), and various consumables are also very expensive. Affected by factors such as the price and the medicine supply, medicines have high variability, causing increase in later investment (medicine box manufacturing). Besides, medicine powder can cause powder pollution, and small crashed medicine pills will be misjudged as a complete medicine tablet through optical detection of the device to be packed, resulting in the phenomenon of missing and insufficiency of medicines. Due to such problems, it is difficult to directly produce small-sized household appliances in the original principle.

A Chinese patent, Publication No. CN 2824907Y, discloses an automatic medicine dispensing device for pharmacies, adopting a negative pressure suction principle, but the automatic medicine dispensing device for pharmacies is still designed for the automation of hospital pharmacies. From the fuzzy technical realization description it can be found that, the automatic medicine dispensing device for pharmacies does not have the function of verifying the distributed medicines and checking prescriptions, does not adopt the scheme of being free from maintenance by specially assigned persons, and has no design for operation in the non-machine-room environment. Moreover, the automatic medicine dispensing device for pharmacies comprises a computer and groups of motors as well as a controller, resulting in high cost and large size, so it is difficult to directly produce batches of small products.

### BRIEF SUMMARY OF THE INVENTION

The objective of the present invention is to provide a practical, reliable, simple and efficient medicine dispensing device for distributing medicine pills automatically, to fill in the gap of no household automatic oral medicines at present.

To fulfill the above objective, the present invention provides a medicine dispensing device for distributing medicine pills automatically. Specifically, the medicine dispensing device includes a medicine supply system, a sorting system and a control system. The medicine supply system includes a plurality of medicine supply units. The sorting system includes a negative pressure medicine receiving mechanism and a camera subsystem. The negative pressure medicine receiving mechanism has a negative pressure sucking head for sucking medicine pills. The negative pressure sucking head sucks a single medicine pill from a corresponding medicine supply unit. The camera subsystem captures images of medicine pills and sends the images to the control system. The medicine dispensing device also includes a temporary storage cabin for medicine dispensing and a temporary storage cabin for medicine discarding. The temporary storage cabin for medicine dispensing receives expected medicine pills, and the temporary storage cabin for medicine discarding receives non-expected medicine pills.

The camera subsystem includes a transparent board, a camera, a lower lighting unit and an upper lighting unit, wherein the lower lighting unit is disposed at the lower side of the transparent board, and the camera and the upper lighting unit are disposed at the upper side of the transparent board.

Each medicine supply unit includes an upper medicine cabin and a lower medicine cabin; each lower medicine cabin is fixed at the lower side of each corresponding upper medicine cabin; a control valve is disposed between each upper medicine cabin and each corresponding lower medicine cabin; a medicine adding cover is disposed on the upper side of each upper medicine cabin, and a medicine receiving window is formed at the upper side of the wall of each lower medicine cabin.

A free piston is disposed on the inner side of each lower medicine cabin, and the inner cavity of each lower medicine cabin below each corresponding free piston communicates with an air valve.

The medicine supply system also includes two opposite medicine cabin brackets disposed in parallel at an interval; the sorting system is disposed between two medicine cabin brackets in a sliding way through a guide rail; and medicine supply units are fixed on the medicine cabin brackets.

Each medicine cabin bracket is formed with a plurality of grooves corresponding to the medicine supply units; springs and electrodes are disposed in the grooves; and the lower part of each medicine supply unit is fixed in each corresponding groove through a locking mechanism.

The negative pressure medicine receiving mechanism includes a negative pressure hose, a tension spring and a guide sleeve. The tension spring is sleeved on the outer side of the negative pressure hose. The guide sleeve is sleeved on the outer side of the tension spring. The guide sleeve is fixedly disposed. One end of the guide sleeve is disposed in a downward inclined way. The tension spring is connected with a negative pressure sucking head driver for pushing the tension spring to extend along an axis thereof.

The negative pressure medicine receiving mechanism is connected with a dust-powder removal device.

The dust-powder removal device includes an air washing bottle containing water; the air washing bottle is internally provided with at least one negative pressure air return pipe and at least one air inlet pipe. One end of the negative pressure air return pipe communicates with the negative pressure air source of the negative pressure medicine receiving mechanism, and the other end is positioned above the air washing bottle; one end of the air inlet pipe is positioned below the liquid level, and the other end communicates with the pipe of the negative pressure sucking head of the negative pressure medicine receiving mechanism.

The dust-powder removal device also includes a wastewater tank and a dehumidifying chamber; the dehumidifying chamber communicates with the negative pressure air return pipe between the air washing bottle and the negative pressure air source; and the dehumidifying chamber also communicates with the atmosphere and the positive pressure air source via a gating valve.

The wastewater tank is disposed at the lower side of the air washing bottle, and a wastewater collecting window in which the negative pressure sucking head extends is formed on one side of the upper part of the wastewater tank.

The air washing bottle, the wastewater tank and the dehumidifying chamber are disposed in turn from the top down; the dehumidifying chamber is fixed on a base; and the base is formed with three air joint which respectively communicate with a positive pressure air source, a negative pressure air source and the pipe of the negative pressure sucking head.

The positive pressure air source also communicates with the negative pressure air return pipe through a bypass with valve.

The device of the present invention has the following advantages: whether a medicine pill is sucked is judged according to an air pressure sensing signal and by a camera subsystem, in which process the negative pressure suction principle is adopted to ensure that the object sucked each time is a single pill. After the sucking succeeds, the medicine particle is photographed to identify the type, quantity and integrity of the medicine particle; medicine pills passing the identification are expected medicine pills and fall into the temporary storage cabin for medicine dispensing; medicine pills identified to belong to different properties are non-expected medicine pills which fall in the temporary storage cabin for medicine discarding, greatly simplifying the procedure of taking different types of medicines for people. Just by removing the packing and placing the same medicines into the medicine supply system, then medicines required according to the prescription requirements can be obtained from one outlet at a predetermined time with the approval of the user.

The medicine dispensing device for distributing medicine pills automatically is a table product with a flexible, small and ingenuous size. The medicine dispensing device for distributing medicine pills automatically is practical, reliable, simple and efficient, filling in the gap of no household automatic oral medicines at present. The camera subsystem is configured to eliminate adhesion, smashing and missing of medicines and ensure correctness of the distribution of medicines without inspection by specially-assigned persons.

For the disabled or persons with visual and hearing problems, the device provides various user-supporting functions to improve the ease of use. The device has high reliability by adopting mature automation technology, and simplifies necessary service and maintenance and cleaning work through the simplest scheme. The medicine supply system adopts a modular design, so the quantity of the medicine cabins can be flexibly set to meet the individual demands of various users.

### BRIEF DESCRIPTION OF THE DRAWINGS

FIG. 1 is a structural view of a medicine dispensing device for distributing medicine pills automatically.

FIG. 2 is a partial enlarged view of portion A in FIG. 1.

FIG. 3 is a schematic view of pipes of a dust-powder removal device.

In the Figures: 1. process control circuit board; 2. camera; 3. negative pressure sucking head; 4. transparent board; 5. upper medicine cabin; 6. lower medicine cabin; 7. free piston; 8. air nozzle of the medicine cabin; 9. medicine cabin bracket; 10. medicine dispensing cabin; 11. groove; 12. supporting column; 13. rotation driver; 14. medicine discarding cabin; 15. selecting gate; 16. sucking head driver; 17. slider; 18. guide rail; 19. base air joint; 20. position signal light source; 21. base; 22. dehumidifying chamber; 23. negative pressure air return pipe; 24. medicine receiving window; 25. wastewater tank; 26. air inlet pipe; 27. air washing bottle; 28. rotating cover; 29. medicine dispensing cup; 30. medicine discarding cup; 31. bottom palate; 32. tension spring; 33. guide sleeve; 34. electromagnetic valve; 35. electric heater; 36. Bypass; 37. gating valve.

### DETAILED DESCRIPTION OF THE INVENTION

The following embodiments are used for describing the present invention, and not used for limiting the scope of the present invention.

### Embodiment 1

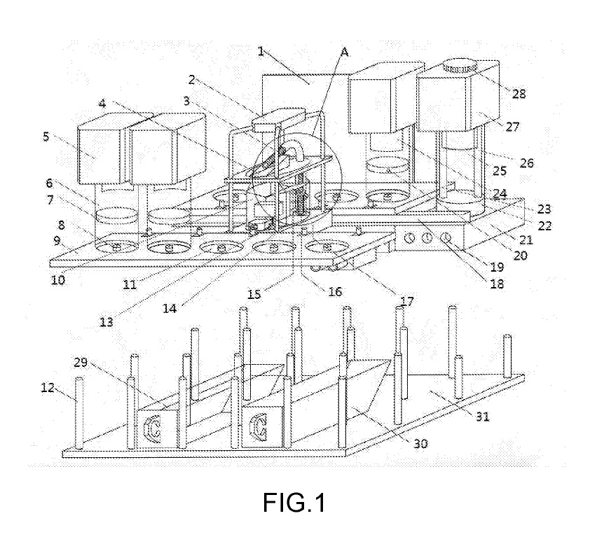

Refer to FIG. 1. A medicine dispensing device for distributing medicine pills automatically includes an automatic pneumatic drug dispensing module and a support system, capable of being applicable to multi-media terminals. The automatic pneumatic medicine dispensing module has complete medicine dispensing functions, has standard electric interfaces and simple pneumatic-powered interface, and can operate by just being electrified with regulated power. The device has quantized size and a universal specification, is in seamless coupling with external systems, and therefore has a lot of advantages such as convenient replacement and extension and large-scale production. Embodiment 1 is a scheme of using a single automatic pneumatic medicine dispensing module. The automatic pneumatic medicine dispensing module consists of a medicine supply system, a sorting system and a control system, and the control system consists of a process control system and a user interface system. The medicine supply system includes a plurality of medicine supply units. The sorting system includes a negative pressure medicine receiving mechanism and a camera subsystem. The negative pressure medicine receiving mechanism has a negative pressure sucking head 3 for sucking medicine pills. The negative pressure sucking head 3 sucks a single medicine pill from a corresponding medicine supply unit. The camera subsystem captures images of medicine pills and sends the images to the control system. The medicine dispensing device also includes a temporary storage cabin for medicine dispensing and a temporary storage cabin for medicine discarding. The temporary storage cabin for medicine dispensing receives expected medicine pills, and the temporary storage cabin for medicine discarding receives non-expected medicine pills. The principle of the automatic pneumatic medicine dispensing module is as follows. First, the sorting system and the medicine supply system generate feedbacks there-between; the actual height of the stacked medicine pills in each medicine supply unit is adjusted to be adapted to the extensible sucking operation of the negative pressure sucking head 3; and whether a medicine pill is sucked is primarily judged according to an air pressure sensing signal. The negative pressure suction principle adopted in the process ensures that the object sucked each time is a single pill. After the sucking succeeds, the medicine pill is photographed, and then the type, quantity and integrity of the medicine pill are identified. Medicine pills passing the identification are descended to the temporary storage cabin for medicine dispensing. Medicine pills which are identified to belong to different attributes fall in the temporary storage cabin for medicine discarding. The procedures are repeated until the execution of the current medicine dispensing prescription is completed. At this time, the sorting system moves to a position above a medicine cup placed by a user, and the temporary storage cabin for medicine dispensing opens a lower door and dispenses the medicines. If medicine pills exist in the temporary storage cabin for medicine discarding, the medicines particles will be exhausted to a designated position, usually, the medicine discarding cup.

The sorting system is the core of the medicine dispensing device, mainly responsible for sucking medicine pills using negative pressure, scanning the state of photoelectric signals, operating all mechanical structures of other systems, capturing images of the sucked medicines, caching and then dispensing qualified medicines in need. Besides, the medicine dispensing device for distributing medicine pills automatically is optimized in design, material selection and production, is easily processed, and therefore is low in cost and adapted to the consumption capabilities of individual users. The medicine dispensing device for distributing medicine pills automatically has a fault self-inspection program, and together with multi-media interfaces, can obtain remote supports, reducing labor load of after-sales service persons.

In embodiment 1, the sorting system shaped like a tower is actually a mechanical arm. The sorting system is placed on a slider 17. Pulled by a belt, the sorting system moves linearly among the medicine supply units; the air pressure power needed by the sorting system is in connection with the support system via a hose; and electronic signals and a power supply are also connected to the process control system via flat cables. The camera subsystem includes a transparent board 4, a camera 2, a lower lighting unit and an upper lighting unit, wherein the lower lighting unit is disposed under the transparent board 4, and the upper lighting unit is disposed above the transparent board 4. The overhead camera 2 is placed at the tower top of the sorting system. In embodiment 1, the camera 2 is a micro camera. The camera 2 directly installed downward, facing the transparent board 4, capable of capturing medicines on the transparent board 4. The lower lighting unit ensures that the camera 2 captures shadows of the medicines to obtain clear medicine profiles, so accurate judgments can be made. The negative pressure sucking head 3 is located between the transparent board 4 and the camera 2, capable of extending and moving in the lower inclined direction. The negative pressure sucking head 3 has a silica gel suction nozzle at the most front tip, and a brush for auxiliary support and cleaning is disposed below the suction nozzle.

The transparent board 4 is the primary carrier of medicines taken from the medicine supply units by the negative pressure sucking head 3. The transparent board 4 is pushed by a pneumatic push rod to rotate around the own front edge line to present three states: upward inclined, horizontal and vertical. The upward inclined angle of the board is complementary with the movement depression angle of the negative pressure sucking head, in which state the platform for bearing the negative pressure sucking head and sucked medicines is formed; in the horizontal state, the platform for capturing and checking medicines is formed; and in the vertical state, medicines fall onto a gate 15. The selecting gate 15 is positioned in the sorting system and is an electromagnetic door, with lower side connected to the temporary storage cabin for medicine dispensing and the temporary storage cabin for medicine discarding. In embodiment 1, the temporary storage cabin for medicine dispensing is a medicine dispensing box 10; the temporary storage cabin for medicine discarding is a medicine discarding box 14; the selecting gate 15 normally communicates with the medicine discarding box 14; when qualified medicine pills are received, the selecting gate 15 switches to be connected with the medicine dispensing box 10, and then the medicine pills naturally fall into the medicine dispensing box 10.

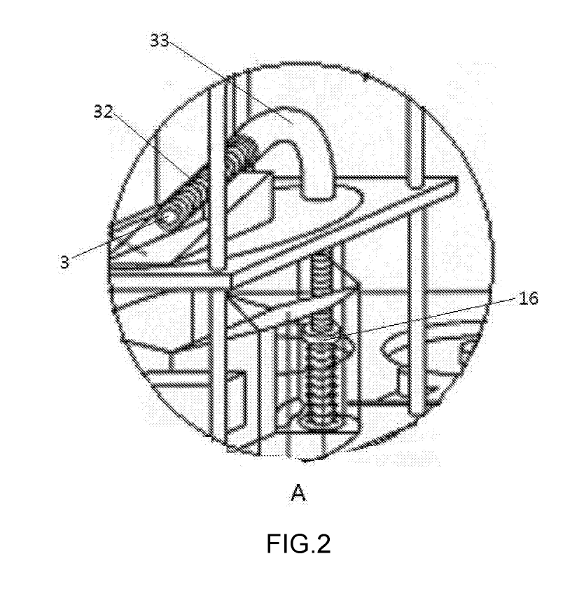

Refer to FIG. 2. The negative pressure medicine receiving mechanism includes a negative pressure hose, a tension spring 32 and a guide sleeve 33. The tension spring 32 is sleeved on the outer side of the negative pressure hose. The guide sleeve 33 is sleeved on the outer side of the tension spring 32. The guide sleeve 33 is fixedly disposed. One end of the guide sleeve 33 is disposed in a downward inclined way. The tension spring 32 is connected with a negative pressure sucking head driver 16 for move the tension spring to run along an axis thereof. The guide sleeve 33 is actually reversed V-shaped with rounded corners, having one end being vertical and the other end downward inclined and point to the medicine supply units. The tension spring 32 is compact, so the suspended segment of the tension spring 32 and the negative pressure hose can keep straight line shaped, are superimposed with the axis of the guide sleeve 33, and point to the medicine supply unit, either the negative pressure sucking head 3 runs along the axis thereof when the tail end of the tension spring 32 is driven, and their axis has a certain downward inclined angle. The pivot of the transparent board 4 is on one side close to the medicine supply unit, so that the transparent board is inclined upward to be parallel to the downward inclined axis of the V tube. In such state, the transparent board supports the movement of the negative pressure sucking head 3.

The medicine dispensing box 10 and the medicine discarding box 14 both have normally-closed electromagnetic doors at lower ends. At proper time, the electromagnetic door opens, and then medicine pills fall into a medicine dispensing cup 29 and a medicine discarding cup 30 below the slider 17. The slider 17 can be pulled in a way that an opening points at the medicine dispensing cup 29. The sorting system is concerned with a lot of electronic signals and drive currents, so a CPU command is transmitted to a local MCU via a serial data bus, is decoded and then cached as a switching signal constant for operating a corresponding actuator.

The negative pressure sucking head driver 16 and a sorting tower revolving motor are positioned next to the medicine dispensing box 10 and the medicine discarding box 14. The negative pressure sucking head driver 16 is connected with the tension spring 32, is driven by an air cylinder to linearly displace in two ways, and is controlled by feedback signals from a corresponding position sensor. In embodiment 1, the negative pressure hose is an extension tube having a fixed end connected with an air pressure sensor of which the change in the pressure value is used for primarily judging whether medicine pills are sucked. All air source interfaces connected to the system are equipped with the air pressure sensor for fault self-inspection.

In embodiment 1, the medicine supply units are medicine cabins. The power supply system is an array of medicine cabins, used for storing medicines and cooperating with the sorting system to dispense medicines, including a medicine cabin bracket 9 and medicine supply units. A user can add medicine pills to be taken into the medicine cabins and can conveniently take out the medicine cabins to check and clean.

Each medicine cabin is a cylindrical structure, divided into two layers, including an upper medicine cabin 5 on the upper layer and a lower medicine cabin 6 on the lower layer. The upper medicine cabin 5 is a square space with rounded corners, used for storing medicine pills added by a user. A medicine adding cover (not shown in the figure) is installed on the top of each medicine cabin. The medicine adding cover is provided with a self-locking mechanism and can be opened and closed by the effect of the corresponding push rod of the sorting system. The lower medicine cabin 6 is a transparent cylindrical tube, with an outer diameter a little smaller than the width of the upper medicine cabin; a square hole of ¼ circumference, facing the center of the medicine dispensing device, is formed at the upper part of the wall of the lower medicine cabin; the square hole is a medicine receiving window 24; and the negative pressure sucking head 3 sucks medicine pills through the window. A revolving door of ¾ circumference externally surrounds the medicine receiving window 24. A gate is disposed between the upper medicine cabin 5 and the lower medicine cabin 6. The gate and the revolving door can be driven to open and close by corresponding push rods of the sorting system. The medicine receiving window 24 has a lower edge extending to form a horizontal platform and the front edge of platform is tangent to the transparent board 4, and the width of the front edge is equal to the outer edge of the upper medicine cabin 5. An indent air joint is formed in the bottom center of the lower medicine cabin 6; vertical rack are installed at an outside position, close to the medicine dispensing device, of the lower medicine cabin; the indented air joint, the vertical rack and the medicine cabin bracket 9 are mated to form a quick-pressurized locking mechanism. A tubular cavity of the lower medicine cabin 6 is internally provided with a free piston 7, and has a lower space communicating with a mastoid air tap 8, so the free piston 7 rises and descend by the effect of pressure of introduced air. A position signal light source 20, facing the inner side of the device, is disposed on the upper plane of each free piston 7 to supply signals to a medicine amount monitor of the sorting system, and a power cable of the position signal light source 20 penetrates each lower medicine cabin 6 from the top and is finally connected to an electrode at the bottom of each cabin.

The medicine cabin bracket 9 is the common base of the medicine cabin array, fixes the medicine cabin, and supplies the medicine cabins with electricity and air power. Two medicine cabin brackets 9 are disposed in parallel on two sides of a guide rail 18 of the sorting system; the cabin capacity of the medicine cabin bracket 9 on one side is smaller, by the capacity of one cabin, than the cabin capacity of the medicine cabin bracket 9 on the other side, wherein the longer medicine cabin bracket 9 is as long as the guide rail 18 and shall be n times the medicine cabin width. Each medicine cabin bracket 9 is distributed with n cylindrical grooves 11 at an equal interval, and has the spring, the electrodes, the air nozzle and the locking mechanism with ratchets, which are matched with medicine cabins. The air nozzle are merged into a main air pipe of each medicine cabin bracket 9 via corresponding normally-closed micro air valves. The normally closed micro valves are positioned on one side close to the sorting system, and manipulated by push rods extended by the sorting tower to decide to drive the free piston 7 to move or not. The main air pipe of each medicine cabin bracket 9 is equipped with an air pressure sensor, and communicates with a positive pressure air source and a negative pressure air source via electromagnetic valves to regulate the movement direction of the corresponding piston in the corresponding medicine cabin. The locking mechanism with the ratchet has a reset sensor for locking corresponding medicine cabins; the ratchet are connected to keys, close to one side of the sorting system, via a transmission rod; and the locked medicine cabins are released by the push rods extended by the sorting tower. The electrode groups are gathered in parallel to one power supply interface. 2n−1 reset signals, two air pressure signals and four valve-driven currents concerned with the system are connected to the process control system via standard interfaces.

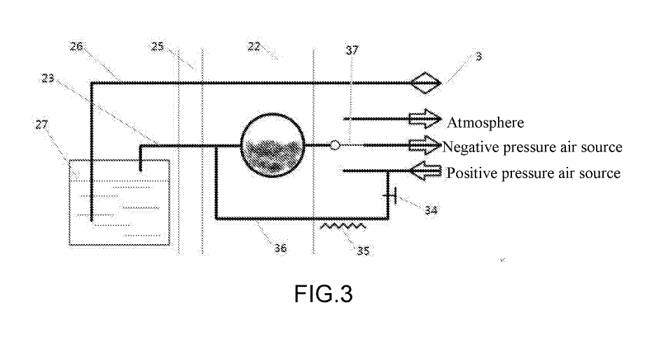

Refer to FIG. 1 and FIG. 3. Medicine pills generate powder and chips through collision and friction, and medicine cabins are of closed designs, so powder has limited influence on the environment, but can seriously pollute the negative pressure sucking head 3 and a pipe thereof. A dust-powder removal device used for removing powder pollution is connected between the negative pressure sucking head 3 and a negative pressure air source of the sorting system, wherein the working media is water, and air generates air bubbles in water. In embodiment 1, the dust-powder removal device includes two parts, a namely a base 21 and a washing bottle which are installed next to the shorter medicine cabin bracket 9 and are in line with the medicine cabins. The base 21 is fixed; a lock is disposed between the washing bottle and the base 21; and the lock is ratchet shaped, so the washing bottle can be conveniently taken out to replace water and to be washed. The base 21 has three base air joint 19 in connection with an air nozzle at the bottom of the washing bottom. The base 21 has four air pipes to the outside, one of which communicates with the atmosphere, and the other three of which respectively lead to the negative pressure sucking head 3, the positive pressure air source and the negative pressure air source of the sorting system. An impact electromagnet is positioned next to the lock to drive air valves in the washing bottle.

The maximum dimension of the washing bottle is not greater than the dimension of the medicine cabin. The washing bottle is a three-layer structure, having an air washing bottle 27 on the upper layer, a wastewater tank 25 on the middle layer and a dehumidifying chamber 22 on the lower layer. A revolving cover 28 is disposed on the top of the air washing bottle 27 to facilitate water adding. The air washing bottle 27 is internally provided with a negative pressure air return pipe 23 and an air inlet pipe 26. One end of the negative pressure air return pipe 23 is inserted in the dehumidifying chamber 22 and communicates with a gating valve 37 which normally connects to negative pressure air source, and the other end is positioned above the liquid level of the air washing bottle 27. In this way, vapor is prevented from condensing in the pipe to cause damage. One end of the air inlet pipe 26 is positioned below the liquid level, and the other end communicates with a hose of the negative pressure sucking head 3. The dehumidifying chamber 22 is internally filled in with reversible desiccants. The process that the negative pressure sucking head 3 sucks medicine pills is an air washing process. Powder-containing air sucked by the negative pressure sucking head 3 is introduced into water via the air inlet pipe 26, realizing washing. Like the tubular cavity of the lower medicine cabin 6, the wastewater tank 25 is provided with a wastewater collecting window at a position as high as the negative pressure sucking head 3, is externally wrapped with a revolving door of which the opening and closing manner is the same as that of the medicine receiving window 24 of the lower medicine cabin 6. When the sorting system faces the washing bottle and the negative pressure sucking head 3 extends into the wastewater tank 25, the gating valve 37 connects to the positive pressure air source, and some water in the air washing bottle 27 is pushed into the negative pressure sucking head 3 and the pipe thereof, thereby realizing pipe washing. In order to dry the desiccants, by the effect of the valve 34 and gating valve 37, the dehumidifying chamber 22 generates a bypass 36 between a positive pressure hot air and the atmosphere. Specifically, the positive pressure air source generates a bypass 36 which communicates with an inlet of the dehumidifying chamber 22 via an electromagnetic valve 34. The channel wall of the bypass 36 is laid with an electric heater 35, and heated air is led to the atmosphere via the dehumidifying chamber 22, thus drying the desiccants.

The sorting system is also equipped with air pressure push rods for opening and closing top covers of medicine cabins and medicine receiving windows 24, wedges for resetting and locking the medicine cups, and electromagnets for driving the lifting air valves of the medicine cabins. In order to ensure that the sorting system can serve the medicine cabins on two sides, the lower part of the sorting system is connected with a rotation driver 13, and the rotation driver 13 includes a rotation motor and a gear; a bearing is disposed between the sorting tower and the slider 17; the rotation motor is fixed on the inner wall of the tower, and is coupled with a small-diameter gear; the small-diameter gear is meshed with an inner gear ring fixed on the slider 17; and under proper control, the rotation motor rotates to drive the sorting system to rotate 180 DEG.

The process control system includes a set of electronic circuits, and a process control circuit board 1 of the process control system is fixed beside of the smaller medicine cabin bracket 9. The process control circuit board 1 is responsible for receiving signals from all sensors, generating control signals or commands according to digital logic feedback to maintain the operation of the device, and supplying electricity to other systems in the medicine dispensing module at the same time.

The process control electronic circuits perform DC voltage transformation for itself and supply the transformed voltage to other systems in the medicine dispensing module. The electronic circuits are wired as a minimum system around an ARM processor. A Linux operating system operates on the ARM processor, supplying working commands, communication services and multi-media supports to the medicine dispensing module. The electronic circuits include transmission analog circuits required by sensors in all systems. Some of the processed sensing signals are inputted into a self-owned data converter of the ARM processor, and signals with demands on accuracy or speed are processed by special analog-digital converters on the circuit board. The circuits have sensors for measuring temperature and humidity in the medicine dispensing device for monitoring the storage conditions of medicines. The circuits are also internally provided with a series for controllers for driving motors, and crystal power amplifier tubes or relays for driving electrical components such as electromagnets and heating wires.

The user interface is an operating interface between the user and the device, including a character liquid crystal display screen, a loudspeaker, five keys and a multi-media data link. The liquid crystal display screen and the speaker synchronously display and broadcast notices or inquiries to the user to meet special demands of the visually disabled persons. Controlled by the ARM processor, the speaker broadcasts pre-recorded voices. After carefully listening to the voices, the user can input decisions through the keys, require more options, select different items, etc. The data link includes establishment of connection with a computer, a tablet PC or a smart mobile phone via the Ethernet, a USB cable, wifi or blue-tooth, communication through a self-defined transmission protocol, and supply of more multimedia interaction manners to users through Apps on the computer, the tablet PC or the smart mobile phone.

The support system is adapted to the standard electric interfaces and air pressure power interfaces of the automatic pneumatic medicine dispensing module, supplying power to the automatic pneumatic medicine dispensing module. Meanwhile, the support system has a box and an internal structure which provide support and protection for the whole device, and also reserves berths for the medicine dispensing cup 29 and the medicine discarding cup 30.

Power support mainly refers to an external power adapter which can rectify the mains supply into a DC voltage below a safety voltage and ensure sufficient power. The air pressure power sources include two paths, namely a negative one and a positive one, which is respectively provided with components such as an air pump, an air storage tank, an air pressure sensor and an automatic pressure maintaining control circuit, wherein the automatic pressure maintaining control circuit sends a qualified air pressure signal to the process control system. The electrical power and air pressure power are supplied to the standard interfaces of all systems of the medicine dispensing system via adapters. The box structure includes two parts, namely a base and a housing. A plurality of supports is disposed on the base plate to jack up the automatic medicine dispensing module. The supports are arrayed along the rail of the sorting system and the outer edges of the medicine cabin brackets 9 and are aligned with the medicine cabins at an interval. A belt traction motor, an air pump, a plurality of air storage tanks, a plurality of medicine dispensing cups 29 and a medicine discarding cup 30 are accommodated in spaces formed among the supports. The width and height of the medicine dispensing module are fixed values, and the length changes along with the demand of the user on the medicine cabin quantity, which is good for the assembling and shaping of the housing.

The control process of the medicine dispensing device includes the following procedures:

medicine receiving: When the level of the medicines in each lower medicine cabin 6 is adjusted to a proper value, the negative pressure sucking head 3 extends into the lower medicine cabin 6 to suck medicine pills; once a medicine particle is sucked, the pressure in the negative pressure sucking head 3 rises dramatically; the process control system sends a command to make the negative pressure sucking head 3 to move back below the camera 2; the lower lighting unit of the transparent board 4 turns on, while the upper lighting unit turns off; after the image of the medicine particle shadow and profile is captured, edge test is carried out; if the test result is a failure, the negative pressure sucking head 3 moves forward to suck a medicine particle again; if it is primarily affirmed that the sucking succeeds, the transparent board 4 descends to be horizontal, while the negative pressure of the negative pressure sucking head 3 is canceled such that the medicine particle falls on to the transparent board 4; then, the upper lighting unit turns on, the lower lighting unit turns off, the camera 2 captures the image of the medicine particle; the control system identifies the image, compares the image with the correct medicine particle image to check the type, integrity and properties of the medicine particle, judges whether the medicine particle is an expected medicine particle or an non-expected medicine particle according to the check result, and then controls the selecting gate 15; next, the transparent board 4 turns to vertically face down to put the medicine particle into the corresponding cache cabin. Such procedure is repeated in turn until the sucking of each type of medicine pills on prescription is completed. The base plate 31 is fixed below the medicine cabin brackets 9 through supporting columns 12; the medicine dispensing cups 29 and the medicine discarding cups 30 are disposed on the base plate 31 for respectively receiving medicine pills in the medicine dispensing cabin 10 and the medicine discarding cabin 14.

Removal of dust and powder: Powder-containing air sucked by the negative pressure sucking head 3 is introduced into water via the negative pressure air return pipe 23, realizing washing. When the negative pressure sucking head 3 extends into the wastewater tank 25, the negative pressure air return pipe 23 is connected with the positive pressure air source, and some water in the air washing bottle 27 is pushed into the negative pressure sucking head 3 and the pipe thereof, and the wastewater is pushed into the wastewater tank 25, thereby realizing washing.

### Embodiment 2

In embodiment 2, the dust-powder removal device includes the air washing bottle 27 containing water; the air washing bottle 27 is internally provided with at least one negative pressure air return pipe 23 and at least one air inlet pipe 26. One end of the negative pressure air return pipe 23 communicates with the negative pressure air source of the negative pressure medicine receiving mechanism, and the other end is positioned above the liquid level of the air washing bottle 27; one end of the air inlet pipe 26 is positioned below the liquid level, and the other end communicates with the pipe of the negative pressure sucking head 3 of the negative pressure medicine receiving mechanism. The process that the negative pressure sucking head 3 sucks medicine pills is an air washing process. Powder-containing air sucked by the negative pressure sucking head 3 is introduced into water via the negative pressure air return pipe 23, realizing washing. In embodiment 2, the structure of the dust-powder removal device is simpler.

### Embodiment 3

Embodiment 3 is different from embodiments 1 and 2 in that, the medicine supply units are arrayed on the circumference of the sorting system in an annular way, and the sorting system sucks medicine pills from each medicine cabin through rotation; and other components are the same as those in embodiment 1.

The present invention is described in detail through general notes and specific embodiments. On the basis of the present invention, some modifications and improvements can be made, which are obvious to those skilled in this field. Therefore, all modifications or improvements made on the basis of the concept of the present invention shall fall within the protective scope claimed by the present invention.

What is claimed is:

1. A medicine dispensing device for distributing medicine pills automatically, comprising a medicine supply system, a sorting system and a control system, characterized in that, the medicine supply system comprises a plurality of medicine supply units; the sorting system comprises a negative pressure medicine receiving mechanism and a camera subsystem; the negative pressure medicine receiving mechanism has a negative pressure sucking head for sucking medicine pills; the negative pressure sucking head sucks a single medicine pill from a corresponding medicine supply unit; the camera subsystem captures images of medicine pills and sends the images to the control system; the medicine dispensing device for distributing medicine pills automatically also comprises a temporary storage cabin for medicine dispensing and a temporary storage cabin for medicine discarding; the temporary storage cabin for medicine dispensing receives expected medicine pills, and the temporary storage cabin for medicine discarding receives non-expected medicine pills.

2. The medicine dispensing device for distributing medicine pills automatically according to claim 1, characterized in that the camera subsystem comprises a transparent board, a camera, a lower lighting unit and an upper lighting unit, wherein the lower lighting unit is disposed under the transparent board, and the camera and the upper lighting unit are disposed above the transparent board.

3. The medicine dispensing device for distributing medicine pills automatically according to claim 1, characterized in that each medicine supply unit comprises an upper medicine cabin and a lower medicine cabin; each lower medicine cabin is fixed at the lower side of each corresponding upper medicine cabin; a control valve is disposed between each upper medicine cabin and each corresponding lower medicine cabin; a medicine adding cover is disposed on the upper side of each upper medicine cabin, and a medicine receiving window is formed at the upper side of the wall of each lower medicine cabin.

4. The medicine dispensing device for distributing medicine pills automatically according to claim 3, characterized in that a free piston is disposed in each lower medicine cabin, and the inner cavity of each lower medicine cabin below each corresponding free piston communicates with an air valve.

5. The medicine dispensing device for distributing medicine pills automatically according to claim 3, characterized in that the medicine supply system also comprises two opposite medicine cabin brackets disposed in parallel at an interval; the sorting system is disposed between two medicine cabin brackets in a sliding way through a guide rail; and medicine supply units are fixed on the medicine cabin brackets.

6. The medicine dispensing device for distributing medicine pills automatically according to claim 5, characterized in that each medicine cabin bracket is formed with a plurality of grooves corresponding to the medicine supply units; springs and electrodes are disposed in the grooves; and the lower part of each medicine supply unit is fixed in each corresponding groove through a locking mechanism.

7. The medicine dispensing device for distributing medicine pills automatically according to claim 1, characterized in that the medicine supply system also comprises two opposite medicine cabin brackets disposed in parallel at an interval; the sorting system is disposed between two medicine cabin brackets in a sliding way through a guide rail; and medicine supply units are fixed on the medicine cabin brackets.

8. The medicine dispensing device for distributing medicine pills automatically according to claim 7, characterized in that each medicine cabin bracket is formed with a plurality of grooves corresponding to the medicine supply units; springs and electrodes are disposed in the grooves; and the lower part of each medicine supply unit is fixed in each corresponding groove through a locking mechanism.

9. The medicine dispensing device for distributing medicine pills automatically according to claim 1, characterized in that the negative pressure medicine receiving mechanism comprises a negative pressure hose, a tension spring and a guide sleeve; the tension spring is sleeved on the outer side of the negative pressure hose; the guide sleeve is sleeved on the outer side of the tension spring; the guide sleeve is fixedly disposed; one end of the guide sleeve is disposed in a downward inclined way; and the tension spring is connected with a negative pressure sucking head driver for pushing the tension spring to extend along an axis thereof.

10. The medicine dispensing device for distributing medicine pills automatically according to claim 1, characterized in that the negative pressure medicine receiving mechanism is connected with a dust-powder removal device.

11. The medicine dispensing device for distributing medicine pills automatically according to claim 10, characterized in that the dust-powder removal device comprises the air washing bottle containing water; the air washing bottle is internally provided with at least one negative pressure air return pipe and at least one air inlet pipe; one end of the negative pressure air return pipe communicates with the negative pressure air source of the negative pressure medicine receiving mechanism, and the other end is positioned above the air washing bottle; one end of the air inlet pipe is positioned below the liquid level, and the other end communicates with the pipe of the negative pressure sucking head of the negative pressure medicine receiving mechanism.

12. The medicine dispensing device for distributing medicine pills automatically according to claim 11, characterized in that the dust-powder removal device also comprises a wastewater tank and a dehumidifying chamber; the dehumidifying chamber communicates with the negative pressure air return pipe between the air washing bottle and the negative pressure air source; and the dehumidifying chamber also communicates with the atmosphere and the positive pressure air source via a gating valve.

13. The medicine dispensing device for distributing medicine pills automatically according to claim 12, characterized in that the wastewater tank is disposed at the lower side of the air washing bottle, and a wastewater collecting window in which the negative pressure sucking head extends is formed on one side of the upper part of the wastewater tank.

14. The medicine dispensing device for distributing medicine pills automatically according to claim 13, characterized in that the air washing bottle, the wastewater tank and the dehumidifying chamber are disposed in turn from the top down; the dehumidifying chamber is fixed on a base; and the base is formed with three air joint which respectively communicate with a positive pressure air source, a negative pressure air source and the pipe of the negative pressure sucking head.

15. The medicine dispensing device for distributing medicine pills automatically according to claim 12, characterized in that the air washing bottle, the wastewater tank and the dehumidifying chamber are disposed in turn from the top down; the dehumidifying chamber is fixed on a base; and the base is formed with three air doors which respectively communicate with a positive pressure air source, a negative pressure air source and the pipe of the negative pressure sucking head.

16. The medicine dispensing device for distributing medicine pills automatically according to claim 12, characterized in that the positive pressure air source also communicates with the negative pressure air return pipe through a bypass.
